(19) United States
(12) Patent Application Publication
(10) Pub. No.: US 2023/0387470 A1
(43) Pub. Date: Nov. 30, 2023

(54) GALVANIC MONOCELL AND METHOD FOR PRODUCING THE SAME

(71) Applicant: Volkswagen Aktiengesellschaft, Wolfsburg (DE)

(72) Inventors: Dennis BOEHM, Wolfenbuettel (DE); Tobias JANSEN, Braunschweig (DE); Christian KLEMT, Meine (DE); Alexander TORNOW, Ummern (DE); Marco JORDAN, Salzgitter (DE); Adrian BECKER, Bockenem (DE)

(73) Assignee: Volkswagen Aktiengesellschaft, Wolfsburg (DE)

(21) Appl. No.: 18/203,390

(22) Filed: May 30, 2023

(30) Foreign Application Priority Data
May 31, 2022 (DE) 10 2022 113 630.2

(51) Int. Cl. H01M 10/058; H01M 4/66; H01M 10/0525

(52) U.S. Cl. CPC H01M 10/058; H01M 4/667; H01M 10/0525; H01M 4/668; H01M 4/661

(57) ABSTRACT

A monocell and a method for producing a monocell for a battery cell. In this method, a first separator film, an anode film, a second separator film, and a cathode film are stacked in this sequence to form a film layer arrangement and fed to a thermal cutting process. The cutting of the film layer arrangement is accomplished by a thermal cutting method, wherein a first metal coating on the anode film and a second metal coating on the cathode film vaporize in the cut region. The plastic substrate of the anode melts partially and spreads over the cut surface of the first anode layer and electrically insulates the same. The plastic substrate of the cathode melts partially and spreads over the cut surface of the first cathode layer and electrically insulates the same.

This nonprovisional application claims priority under 35 U.S.C. § 119(a) to German Patent Application No. 10 2022 113 630.2, which was filed in Germany on May 31, 2022, and which is herein incorporated by reference.

### BACKGROUND OF THE INVENTION

### Field of the Invention

The invention relates to a galvanic monocell for producing a cell stack for a battery cell as well as to a method for producing such a galvanic monocell according to the preamble of the independent claims.

### Description of the Background Art

Lithium-ion batteries have attracted a great deal of attention over the past twenty years for a variety of applications in portable electronic devices such as cellular phones and laptops. Powerful, economical lithium-ion batteries are currently one of the most promising options for large-scale energy storage devices because of the rapid development of the market for electric vehicles and energy storage in the power grid.

A lithium-ion battery is generally composed of a separator, a cathode, and an anode. At present, the electrodes are produced by dispersing fine powders of an active battery electrode material, a conductive agent, and a binder in a suitable solvent. The dispersion can be applied to a current collector, such as a copper or aluminum foil, and then dried at elevated temperature to remove the solvent. The cathode and anode sheets are subsequently stacked or rolled, with the separator separating the cathode and the anode, to form a battery.

For the production of lithium-ion cells, it is necessary to construct an electrode-separator composite consisting of anodes and cathodes stacked in alternation, which are each separated from one another in an electrically conductive manner by a separator. On account of the high number of these individual elements and the requisite tight position tolerances, the production of this electrode-separator composite is especially critical with regard to cycle time and the reject rate in the manufacturing process.

One possibility for increasing productivity in manufacturing a cell stack of such an electrode-separator composite is the production of so-called monocells, which have an anode, a first separator, a cathode, and a second separator, as well as the stacking of these monocells to form an electrode-separator composite.

Production of this monocell currently takes place with a laminating process. In this process, the individual elements of the monocell are joined together by pressure and temperature, for example in the following sequence: first separator, anode, second separator, cathode. At present, this is accomplished in that individual anodes are placed on a continuous separator film and are subsequently covered with another separator film. A cathode is placed on this composite consisting of a first separator, an anode, and a second separator. This composite is subsequently laminated together, and singulated into monocells.

Ever more precise stacking processes are being generated for production of the described monocells. However, they are costly, and as process speed increases they lead to ever greater demands on the systems, causing the costs for producing the monocell to rise.

US 2021/0 344 048 A1 describes a method for producing a laminate for a secondary battery. In this method, a bonded body is produced that contains a negative electrode material and separator webs bonded to both surfaces of the negative electrode material. Alternatively, a bonded body is produced that contains a negative electrode material, a first separator web, a positive electrode, and a second separator web, which are bonded in the specified order. Subsequently, the bonded body is singulated into galvanic units by cutting.

From US 2020/0 136 189 A1, a method is known for producing a monocell with a film-like negative electrode, a film-like separator, and a film-like positive electrode, which are laminated in this sequence. In this manufacturing method, adhesives are arranged at a multiplicity of points on an upper surface of the negative electrode, then the negative electrode is bonded to a lower surface of the separator, and in addition, adhesives are arranged at a multiplicity of points on a lower surface of the positive electrode, then the positive electrode is bonded to an upper surface of the separator. Viewed in the lamination direction of the monocell, the positions of the adhesives and the positions of the bonding agents do not overlap one another.

After that, the adhesives are arranged at a multiplicity of points on a top side of the positive electrode, and a bottom side of a separator is adhered to the top surface of the positive electrode.

Furthermore, a galvanic element is known from DE 10 2014 201 310 A1 with at least two current conductors, at least one positive electrode, and at least one negative electrode, as well as at least one ionic conductor, wherein the current conductors are implemented as plastic film with metal coating. Instead of a metal film here, DE 10 2014 201 310 A1 proposes using a plastic film with a metallic coating as current conductor in order to reduce the thickness of the current conductor in the galvanic element.

### SUMMARY OF THE INVENTION

It is therefore an object of the invention to simplify the production process of a monocell and to overcome the disadvantages known from the prior art.

This object is attained in an exemplary embodiment by a method for producing a monocell for a battery cell that comprises the following steps: feeding a first separator film for electrical separation of an anode and a cathode of the monocell; feeding an anode film, wherein the anode film has a first current conductor as well as a first anode layer and a second anode layer, which embed the first current conductor between the first and second anode layers; feeding a second separator film for electrical separation of an anode and a cathode of the monocell; feeding a cathode film, wherein the cathode film has a second current conductor as well as a first cathode layer and a second cathode layer, which embed the second current conductor between the first and the second cathode layers, wherein at least one of the current conductors is produced from a plastic substrate that is provided with a metal coating; producing a film layer arrangement from the first separator film, the anode film, the second separator film, and the cathode film; cutting the film layer arrangement by means of a thermal cutting method, wherein the metal coating on the plastic substrate vaporizes, and the plastic substrate melts partially and spreads over the cut surface of the first anode layer or of the first cathode layer and electrically insulates the same.

The method permits especially fast and economical production of monocells for a cell stack of a battery cell. Costly stacking processes can be replaced in this case by a simple layering of strip materials, wherein the cut edge of the monocell is electrically insulated by the melting of the plastic material of the plastic substrates, and consequently prevents a short circuit in a monocell.

In an example, provision can be made that the anode film has a first current conductor made of a first plastic substrate that is provided with a first metal coating, that the cathode film has a second current conductor made of a second plastic substrate that is provided with a second metal coating, wherein, during cutting of the film layer arrangement by means of a thermal cutting method, the first metal coating on the anode film and the second metal coating on the cathode film vaporize in the cut region, wherein the first plastic substrate melts partially and spreads over the cut surface of the first anode layer and electrically insulates the same, and wherein the second plastic substrate melts partially and spreads over the cut surface of the first cathode layer and electrically insulates the same. The process can be further improved by two substrates with a plastic core and an electrically conductive metallic coating. In particular, the electrical insulation at the cut edge is further improved so that the risk of an electrical short circuit in the battery cell is minimized.

The films of the film layer arrangement can be laminated to one another, and consequently form a film composite, prior to the thermal cutting. The anode film, the cathode film, and the separator films can be fixed in their positions relative to one another by a laminating, thus preventing a shifting of a film layer before or during the cutting process for singulation of the monocells.

The films of the film layer arrangement can be pressed together by a compression unit. Pressing the layers together can prevent entrapment or air bubbles between the individual films of the film layer arrangement, thus further reducing the risk of an irregular cut edge in the thermal cutting process.

The thermal cutting method can be a laser cutting method. By means of a laser cutting method, a large quantity of heat can be applied in a targeted way to a cutting point especially simply. This not only permits a clean cut edge, but also makes possible in a simple manner that the metallic coatings of the plastic substrates vaporize during the cutting process and the plastic of the plastic substrate melts in order to electrically insulate at least sections of the cut edge.

Also, the thermal cutting method can be carried out by means of an ultrasonically excited cutting tool, wherein the cutting tool and/or the film layer arrangement is/are heated by means of ultrasound.

A laser can cut the film layer arrangement in the following sequence: cathode film, second separator film, anode film, and first separator film. For a subsequent process of stacking the monocells to form a cell stack of a battery cell, it is desirable if the anodes completely cover the cathodes. By means of the cutting sequence described, more material is removed in the region of the cathode film than in the region of the anode film, so that the cathode of the monocell is smaller than the anode of the monocell.

An auxiliary joining material can be applied in a cutting gap during the thermal cutting process, which material electrically insulates the anode and the cathode from one another at a cut edge. The electrical insulation of cathode and anode can be further improved by an auxiliary joining material in the cutting gap. In particular, an auxiliary joining material allows the use of thinner plastic substrates, since the full amount of plastic required for electrical insulation of the cut edge need not be provided by the melting of the plastic substrate. Furthermore, the process reliability when electrically insulating the cut edge can be improved by the auxiliary joining material, and as a result the process speed can be further increased if necessary.

The auxiliary joining material can be a plastic. Thermoplastic materials such as polyethylene (PE), polypropylene (PP), or polyimide (PI), which have favorable melting properties and distribute themselves over the cut edge in an electrically insulating manner, are especially suitable as joining materials.

A melted plastic substrate and/or an auxiliary joining material can additionally cover the cut edge of a separator film.

The melting of the separator is advantageous because the melted plastic from the plastic substrate or the auxiliary joining material adheres better to the separator than to the layers of the collector. Moreover, a covering of the cut edge of the separator by the melting plastic or the auxiliary joining material makes it possible to completely encase the anode. In this way, the potential of dendrite growth at the cut edges is reduced, and further slipping can be prevented.

Another aspect of the invention relates to a monocell for producing a cell stack in a battery cell, wherein the monocell has a first separator layer, an anode, a second separator layer, and a cathode, wherein the anode has a first anode layer and a second anode layer as well as a first current conductor arranged between the first anode layer and second anode layer, wherein the first current conductor has a plastic substrate with a first metal coating, wherein the cathode has a first cathode layer and a second cathode layer as well as a second current conductor arranged between the first cathode layer and the second cathode layer, wherein the second current conductor has a plastic substrate with a second metal coating, wherein the monocell is produced with a method described in the preceding paragraphs.

Such a monocell can be produced especially easily, quickly, and cost-effectively, with the result that the costs for producing battery cells can be reduced. Furthermore, the sources of defects in the stacking process are eliminated by the proposed method for producing such a monocell, with the result that the reject rate in the cell fabrication of such monocells can be minimized.

The first metal coating of the first plastic substrate can be a copper or nickel coating.

The second metal coating of the second plastic substrate can be an aluminum coating.

The plastic substrate of the anode and the plastic substrate of the cathode can be thicker than the metal coating of the respective plastic substrate. It is ensured by this means that the plastic substrate can provide a sufficiently large amount of plastic material that is available for electrical insulation at the anode or at the cathode as a result of the melting.

The plastic substrate can have a material thickness of 5-50 μm and the metal coating can have a layer thickness of 1-5 μm. In this way, a thin metal layer can be formed that vaporizes quickly and easily at the cut edge during the cutting process, and a sufficiently thick plastic layer is present in order to electrically insulate the cut edge at least in sections.

The plastic substrate can be produced from a thermoplastic material, in particular a polyethylene, a polypropylene, or a polyimide. Films from this group of materials are suitable for forming very thin films with a film thickness of a few micrometers, and have sufficient mechanical strength. Moreover, films from the aforementioned group have favorable melting properties for forming electrical insulation at the cut edge.

The anode layers can be formed as graphite layers, a silicon layer, or a graphite layer containing silicon, and the cathode layers can be formed as layers of an oxide containing lithium or of a lithium iron phosphate.

The various examples and embodiments of the invention can be combined with one another to good advantage unless otherwise stated in the individual case.

Further scope of applicability of the present invention will become apparent from the detailed description given hereinafter. However, it should be understood that the detailed description and specific examples, while indicating preferred embodiments of the invention, are given by way of illustration only, since various changes, combinaitons, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a system for producing a galvanic monocell according to the invention for a cell stack of a battery cell;

FIG. 2 is an enlarged representation of a cutting zone where the film material is cut and singulated into monocells according to the invention,

FIG. 3 is a monocell according to the invention for producing a cell stack in a battery cell; and

FIG. 4 is a flowchart for producing a monocell according to the invention for a cell stack in a battery cell.

### DETAILED DESCRIPTION

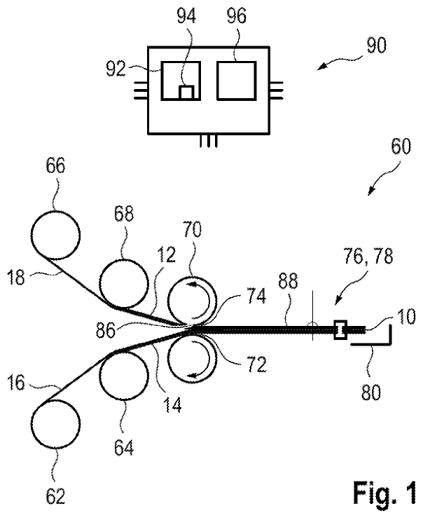

FIG. 1 shows a system 60 for carrying out a method according to the invention for producing galvanic monocells 10 for a cell stack of a battery cell. The system 60 has a first feeding device 62 for feeding an anode film 16 and a second feeding device 64 for feeding a first separator film 14. The system 60 furthermore has a third feeding device 66 for feeding a second separator film 18 and a fourth feeding device 68 for feeding a cathode film 12. The films 12, 14, 16, 18 in this case are stacked in the following order: first separator film 14, anode film 16, second separator film 18, and cathode film 12, so that a film layer arrangement 86 is produced. The system 60 additionally includes a conveyor unit 70, which feeds the individual films 12, 14, 16, 18 to a cutting unit 76. The system can furthermore have a compressor 72 and/or a laminating unit 74 in order to compress the films 12, 14, 16, 18 prior to cutting, and to fix them in place relative to one another by a laminating process. In this way, a continuous film composite 88 can be produced that can comprise all components of the monocell 10.

The cutting unit 76 preferably includes one or more lasers 78, with which the film layer arrangement 86 or the film composite 88 is singulated into monocells 10. For this purpose, the film layer arrangement 86 or the film composite 88 is thermally detached from the continuously fed film material of the films 12, 14, 16, 18 in a melt zone 82. In the melt zone, a metal coating 34, 54 is vaporized onto the current conductors 38, 58 of the anode film 16 or of the cathode film 12, and a plastic substrate 28, 48 of the corresponding current conductor 38, 58 is melted. Furthermore, the cutting unit 76 can have an application unit for an auxiliary joining material, which can be placed in the cutting gap between the film layer arrangement 86 or the film composite 88 and the monocell 10. The system 60 further includes a receiving device 80 for receiving the singulated monocells 10 and making them available for further processing in a next process step.

The system 60 further includes a controller 90 with a memory unit 92 and a computing unit 94 as well as machine-readable program code 96 stored in the memory unit 92. The controller 90 is equipped to carry out a method according to the invention for producing a monocell 10 with such a system 60 when the machine-readable program code 96 is executed by the computing unit 94.

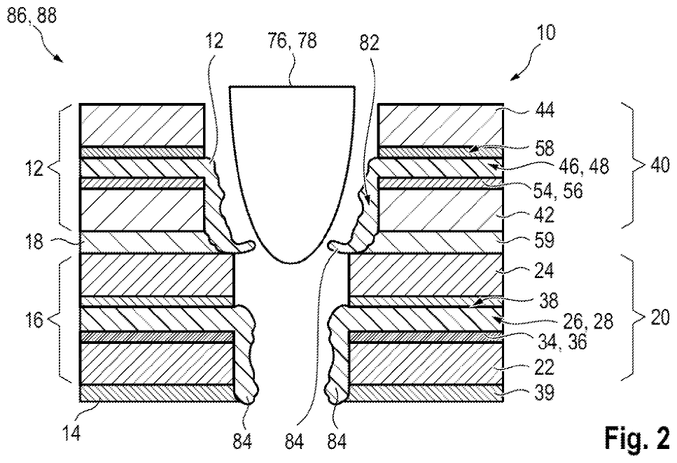

In FIG. 2, a schematic representation is shown of a cutting zone during a thermal cutting process for producing a monocell 10 according to the invention, in which the film material of the film layer arrangement 86 or of the film composite 88 is cut with a thermal cutting element 76, in particular a laser 78, and singulated into monocells according to the invention. The fed film layer arrangement 86 or the fed film composite 88 comprises a first separator film 14, an anode film 16, a second separator film 18, and a cathode film 12. The anode film 16 comprises a first anode layer 22 and a second anode layer 24, which embed an anode substrate 26 in the form of a plastic substrate 28 with a first metal coating 34, in particular a copper coating 36. The cathode film 12 comprises a first cathode layer 42 and a second cathode layer 44, which embed a cathode substrate 46 in the form of a plastic substrate 48 with a second metal coating 54, in particular an aluminum coating 56. The metal-coated plastic substrates 28, 48 serve as current conductors 38 of the cathode 12 or of the anode 16, respectively. The thermal cutting element 76 comprises one or more lasers 78, with which the film layer arrangement 86 or the film composite 88 is severed, and consequently individual monocells 10 are detached from this film layer arrangement 86 or this film composite 88. In the process, the film layer arrangement 86 or the film composite 88 is severed by the thermal cutting unit 76, 78, starting from the cathode film 12. The metal coatings 34, 54 of the plastic substrates 28, 48 are vaporized and the plastic of the plastic substrate 28, 48 is melted in a melt zone 82 in the process. The melted plastic from the plastic substrate 48 of the cathode 40 distributes itself over the cut surface of the first cathode layer 42 and, if applicable, additionally over the cut surface of the second separator film 18 in the process. The melted plastic from the plastic substrate 28 of the anode 20 distributes itself over the cut surface of the first anode layer 22 and, if applicable, additionally over the cut surface of the first separator film 14 in the process. In this way, the cut surfaces are electrically insulated so that the risk of a short circuit in the monocell 10 is prevented.

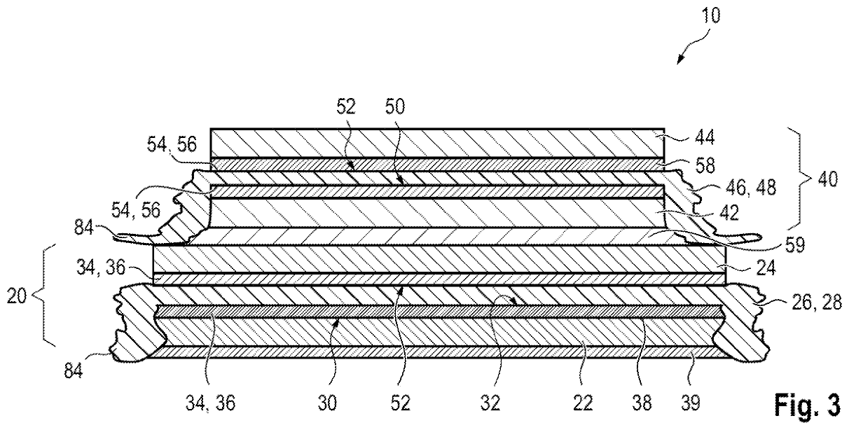

Shown in FIG. 3 is a galvanic monocell 10 according to the invention that is produced with a method according to the invention. The galvanic monocell 10 comprises a first separator layer 39, an anode 20, a second separator layer 59, and a cathode 40. The anode 20 has a first anode layer 22 and a second anode layer 24, which embed an anode substrate 26. The anode substrate 26 has a first plastic substrate 28 that has a metal coating 34, in particular a copper coating 36, on a first surface 30 facing the first anode layer 22 and on a second surface 32 facing the second anode layer 24. The first plastic substrate 28 with the first metal coating 34 serves as current conductor 38 of the anode 20.

The cathode 40 of the galvanic monocell 10 has a first cathode layer 42 and a second cathode layer 44, which embed a cathode substrate 46. The cathode substrate 46 has a second plastic substrate 48 that has a metal coating 54, in particular an aluminum coating 56, on a first surface 50 facing the first cathode layer 42 and on a second surface 52 facing the second cathode layer 44. The second plastic substrate 48 with the second metal coating 54 serves as current conductor 58 of the cathode 40.

Because more material is removed at the cathode 40 than at the anode 20 owing to the thermal cutting method and the chosen cutting direction, the cathode 40 is smaller than the anode 20 located beneath it in the cutting direction.

The cut surfaces of the first cathode layer 42 and the cut surfaces of the first anode layer 22 are wetted, and thus electrically insulated, by the melting plastic from the relevant plastic substrate 28, 48 located thereover.

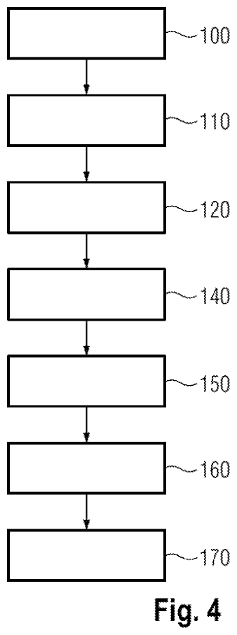

In FIG. 4, a flowchart for carrying out a method according to the invention for producing a galvanic monocell 10 is shown. In a method step <100>, a first separator film 14 for electrical separation of an anode 20 and a cathode 40 of the monocell 10 is fed. In a method step <110>, an anode film 16 is fed, wherein the anode film 16 has a first current conductor 38 made of a first plastic substrate 28 that is provided with a first metal coating 34, and also has a first anode layer 22 and a second anode layer 24, which embed the first current conductor between the first and second anode layers 22, 24. In a method step <120>, a second separator film 18 for electrical separation of an anode 20 and a cathode 40 of the monocell 10 is fed. In a method step <130>, a cathode film 12 is fed, wherein the cathode film 12 has a second current conductor 58 made of a second plastic substrate 48 that is provided with a second metal coating 54, and also has a first cathode layer 42 and a second cathode layer 44, which embed the second current conductor 58 between the first and the second cathode layers 42, 44.

In a method step <140>, a film layer arrangement 86 is produced from the first separator film 14, the anode film 16, the second separator film 18, and the cathode film 12. In a method step <150>, this film layer arrangement can be pressed together and joined together in a laminating process to form a film composite 88. However, this step can also be omitted in a simplified embodiment of the method.

In a method step <150>, the film layer arrangement 86 or the film composite 88 is cut by means of a thermal cutting method, wherein the first metal coating 34 on the anode film 16 and the second metal coating 54 on the cathode film vaporize in the cut region. In the process, the first plastic substrate 28 melts partially and spreads over the cut surface of the first anode layer 22, thus electrically insulating the same. Furthermore, the second plastic substrate 48 melts partially and spreads over the cut surface of the first cathode layer 42, thus electrically insulating the same. In a method step <170>, the monocell 10 cut from the film composite 88 or from the film layer arrangement 86 is received in a receiving unit 80, and can be fed to the further production process for producing a cell stack for a battery cell.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a monocell for a battery cell, the method comprising:
feeding a first separator film to electrically separate an anode and a cathode of the battery cell;
feeding an anode film that has a first current conductor and a first anode layer and a second anode layer, which embed the first current conductor between the first and second anode layers;
feeding a second separator film to electrically separate an anode and a cathode of the battery cell;
feeding a cathode film that has a second current conductor and a first cathode layer and a second cathode layer, which embed the second current conductor between the first and the second cathode layers, wherein at least one of the current conductors is produced from a plastic substrate that is provided with a metal coating;
producing a film layer arrangement from the first separator film, the anode film, the second separator film, and the cathode film; and
cutting the film layer arrangement via a thermal cutting method such that the metal coating on the plastic substrate vaporizes, and the plastic substrate melts partially and spreads over the cut surface of the first anode layer or of the first cathode layer and electrically insulates the same.

2. The method for producing a monocell according to claim 1, wherein the anode film has a first current conductor made of a first plastic substrate that is provided with a first metal coating, wherein the cathode film has a second current conductor made of a second plastic substrate that is provided with a second metal coating, wherein, during cutting of the film layer arrangement via the thermal cutting method, the first metal coating on the anode film and the second metal coating on the cathode film vaporize in the cut region, wherein the first plastic substrate melts partially and spreads over the cut surface of the first anode layer and electrically insulates the same, and wherein the second plastic substrate melts partially and spreads over the cut surface of the first cathode layer and electrically insulates the same.

3. The method for producing a monocell according to claim 1, wherein the films of the film layer arrangement are laminated to one another, and consequently a film composite is formed, prior to the cutting.

4. The method for producing a monocell according to claim 1, wherein the films of the film layer arrangement are pressed together by a compression unit. The method for producing a monocell according to claim 1, wherein the thermal cutting method is a laser cutting method.

6. The method for producing a monocell according to claim 5, wherein a laser cuts the film layer arrangement in the following sequence: cathode film, second separator film, anode film, and first separator film.

7. The method for producing a monocell according to claim 1, wherein an auxiliary joining material is applied in a cutting gap during the thermal cutting process, the auxiliary joining material electrically insulating the anode and the cathode from one another at a cut edge.

8. The method for producing a monocell according to claim 7, wherein the auxiliary joining material is a plastic.

9. The method for producing a monocell according to claim 1, wherein a melted plastic substrate or an auxiliary joining material additionally covers the cut edge of a separator film.

10. A monocell for producing a cell stack in a battery cell, the monocell comprising:
a first separator layer;
an anode having a first anode layer and a second anode layer and a first current conductor arranged between the first anode layer and the second anode layer, the first current conductor having a plastic substrate with a metal coating;
a second separator layer; and
a cathode having a first cathode layer and a second cathode layer and a second current conductor arranged between the first cathode layer and the second cathode layer, the second current conductor having a plastic substrate with a metal coating,
wherein the monocell is produced by the method according to claim 1.

11. The monocell according to claim 10, wherein the metal coating of the plastic substrate of the anode is a copper or nickel coating.

12. The monocell according to claim 10, wherein the metal coating of the plastic substrate of the cathode is an aluminum coating.

13. The monocell according to claim 10, wherein the plastic substrate of the anode and the plastic substrate of the cathode are thicker than the metal coatings of the respective plastic substrate.

14. The monocell according to claim 13, wherein the plastic substrate has a material thickness of 5-50 μm and the metal coatings have a layer thickness of 1-5 μm.

15. The monocell according to claim 10, wherein the plastic substrate is a thermoplastic substrate.
